(19) United States
(12) Patent Application Publication
(10) Pub. No.: US 2024/0085558 A1
(43) Pub. Date: Mar. 14, 2024

(54) LIDAR SENSOR WITH ADJUSTABLE OPTIC

(71) Applicant: LG INNOTEK CO., LTD., SEOUL (KR)

(72) Inventors: Ryan Thomas DAVIS, Austin, TX (US); Mark Allen ITZLER, Princeton, NJ (US)

(73) Assignee: LG INNOTEK CO., LTD., SEOUL (KR)

(21) Appl. No.: 17/979,264

(22) Filed: Nov. 2, 2022

Related U.S. Application Data
(60) Provisional application No. 63/405,718, filed on Sep. 12, 2022.

(51) Int. Cl. G01S 17/10; G01S 7/481; G01S 7/497; G01S 17/931

(52) U.S. Cl. CPC G01S 17/10; G01S 7/4812; G01S 7/4815; G01S 7/4817; G01S 7/4972; G01S 17/931; G02B 27/30

(57) ABSTRACT

Disclosed herein are system, method, and computer program product embodiments for adjusting a transmission field-of-view (Tx FoV). For example, the system includes a lidar sensor with a series of emitters. Each emitter is configured to transmit light pulses away from a vehicle along a transmission axis to form a transmission field-of-view (Tx FoV). At least one detector is configured to receive at least a portion of the light pulses that reflect off of an object within a reception field-of-view (Rx FoV) along a reception axis. A transmit optic is mounted for translation along a transverse axis and configured to intersect each transmission axis without intersecting the reception axis to adjust the Tx FoV without adjusting the Rx FoV.

### CROSS-REFERENCE TO RELATED APPLICATIONS

This application claims the benefit of U.S. provisional application Ser. No. 63/405,718 filed Sep. 12, 2022, the disclosure of which is hereby incorporated in its entirety by reference herein.

### TECHNICAL FIELD

One or more embodiments relate to a lidar sensor with an adjustable optic.

### BACKGROUND

A vehicle may include a sensor system to monitor its external environment for obstacle detection and avoidance. The sensor system may include multiple sensor assemblies for monitoring objects proximate to the vehicle in the near-field and distant objects in the far-field. Each sensor assembly may include one or more sensors, such as a camera, a radio detection and ranging (radar) sensor, a light detection and ranging (lidar) sensor, and a microphone. A lidar sensor includes one or more emitters for transmitting light pulses away from the vehicle, and one or more detectors for receiving and analyzing reflected light pulses. The lidar sensor may include one or more optical elements to focus and direct the transmitted light and the received light within a field-of-view external to the vehicle. The sensor system may determine the location of objects in the external environment based on data from the sensors. The vehicle may control one or more vehicle systems, such as a powertrain, braking systems, and steering systems based on the locations of the objects.

### SUMMARY

In one embodiment, a lidar sensor is provided with a series of emitters, each emitter being configured to transmit light pulses away from a vehicle along a transmission axis to form a transmission field-of-view (Tx FoV). At least one detector is configured to receive at least a portion of the light pulses that reflect off of an object within a reception field-of-view (Rx FoV) along a reception axis. A transmit optic is mounted for translation along a transverse axis and configured to intersect each transmission axis without intersecting the reception axis to adjust the Tx FoV without adjusting the Rx FoV.

In another embodiment, a method is provided for adjusting a transmission field-of-view. Light pulses are transmitted away from a vehicle along at least one transmission axis to form a transmission field-of-view (Tx FoV). At least a portion of the light pulses that reflect off of an object within a reception field-of-view (Rx FoV) are received along a reception axis. A transmit optic is translated along a transverse axis to intersect each transmission axis without intersecting the reception axis to adjust the Tx FoV without adjusting the Rx FoV.

In yet another embodiment, a non-transitory computer-readable medium having instructions stored thereon that, when executed by at least one computing device, cause the at least one computing device to perform operations comprising: transmitting light pulses away from a vehicle to form a transmission field-of-view (Tx FoV); receiving at least a portion of the light pulses that reflect off of an object within a reception field-of-view (Rx FoV); and translating a transmit optic along a transverse axis to adjust the Tx FoV without adjusting the Rx FoV.

### BRIEF DESCRIPTION OF THE DRAWINGS

FIG. 1 is a front perspective view of an exemplary vehicle with a self-driving system (SDS) that includes a lidar sensor with an adjustable transmission field-of-view (Tx FoV), in accordance with aspects of the disclosure.

FIG. 2 is a schematic diagram illustrating communication between the SDS and other systems and devices, in accordance with aspects of the disclosure.

FIG. 3 is an exemplary architecture of a lidar sensor of the SDS, in accordance with aspects of the disclosure.

FIG. 4 is a top view of a lidar sensor, in accordance with aspects of the disclosure.

FIG. 5 is a section view of the lidar sensor of FIG. 4, taken along section line V-V, in accordance with aspects of the disclosure.

FIG. 6 is a schematic diagram of a lidar sensor providing a Tx FoV, in accordance with aspects of the disclosure.

FIG. 7 is a schematic diagram of another lidar sensor, illustrated with a transmit optic adjusted to a first position to adjust the Tx FoV to a first region relative to the overall Tx FoV, in accordance with aspects of the disclosure.

FIG. 8 is another schematic diagram of the lidar sensor of FIG. 7, illustrated with the transmit optic adjusted to a second position to adjust the Tx FoV to a second region relative to the overall Tx FoV, in accordance with aspects of the disclosure.

FIG. 9 another schematic diagram of the lidar sensor of FIG. 7, illustrated with the transmit optic adjusted to a third position to adjust the Tx FoV to a third region relative to the overall Tx FoV.

FIG. 10 illustrates the overall Tx FoV of FIG. 7 and a reception field-of-view (Rx FoV), in accordance with aspects of the disclosure.

FIG. 11 illustrates the relationship between the adjusted Tx FoV and the Rx FoV, in accordance with aspects of the disclosure.

FIG. 12 is a flow chart illustrating a method for adjusting a Tx FoV, in accordance with aspects of the disclosure.

FIG. 13 is detailed schematic diagram of an example computer system for implementing various embodiments, in accordance with aspects of the disclosure.

In the drawings, like reference numbers generally indicate identical or similar elements. Additionally, generally, the left-most digit(s) of a reference number identifies the drawing in which the reference number first appears.

### DETAILED DESCRIPTION

As required, detailed embodiments are disclosed herein; however, it is to be understood that the disclosed embodiments are merely exemplary and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Rotating optical sensors, such as a rotating lidar sensor, may include complex physical and electrical architectures. A rotating lidar sensor may scan a wide 360-degree field-of-view (FoV) around a vehicle. The region to which the emitters of the lidar sensor transmit light is referred to as a transmission (Tx) FoV and the region from which the detectors of the lidar sensor receive light is referred to as a reception (Rx) FoV. Typically, the Tx FoV and the Rx FoV overlap.

The rotating lidar sensor may include a linear array of emitters to provide a Tx FoV that is extended over a wide vertical area. In such a rotating lidar sensor, the range and the Tx FoV are inversely related. The larger the Tx FoV, the more the optical power is spread, and the less light is transmitted onto a small target. In certain scenarios a self-driving system (SDS) may be more interested in maximizing the Tx FoV, however in other scenarios, the SDS may be more interested in maximizing range over a more limited Tx FoV, for example, when identifying an unknown object in the far-field. Certain objects may be difficult to identify, such as tire debris, because it is not reflective and an irregular shape.

According to some aspects, the SDS adjusts the Tx FoV without adjusting the Rx FoV to maximize the Rx FoV under certain conditions, and to maximize range over a smaller Rx FoV under other conditions. The lidar sensor includes a transmitter assembly with an adjustable transmit optic that is controlled to translate vertically to adjust the Tx FoV without adjusting the Rx FoV. The transmit optic changes the divergence of the transmitted beam to focus Tx FoV within a smaller region of the Rx FoV, which increases the processing power of the lidar sensor by decreasing the overall size of the point cloud to be analyzed. By decreasing the Tx FoV, the photons emitted by the emitters onto the target are increased for the smaller region of interest. In this case, the spatial resolution is not increasing as the Rx FoV does not change.

If the lidar sensor were to adjust the Tx FoV and the Rx FoV, then it would need to synchronize the adjustment to ensure the emitters and detectors are scanning the same region of the FoV. One benefit to adjusting the Tx FoV without adjusting the Rx FoV, is that the detector does not need to know the exact location where the Tx FoV is adjusted to, as long as it remains within the Rx FoV. Another benefit of adjusting the Tx FoV without adjusting the Rx FoV is that this can be done without any additional moving electronics because the emitters, the detectors, and the associated detector lenses do not translate.

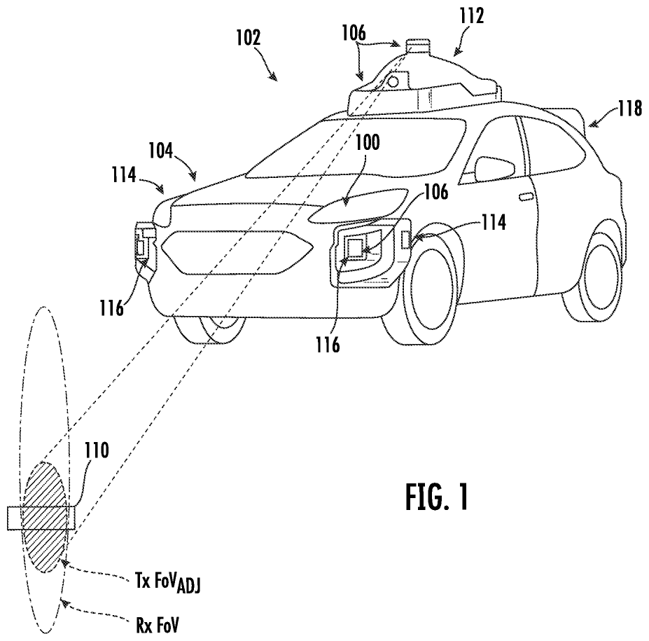

With reference to FIG. 1, a lidar sensor is illustrated in accordance with one or more embodiments and generally referenced by numeral 100. The lidar sensor 100 is integrated with a self-driving system (SDS) 102 of a vehicle 104, such as a self-driving vehicle. The SDS 102 includes a plurality of sensors 106 to monitor an external environment of the vehicle 104. The lidar sensor 100 adjusts a transmission field-of-view (Tx FoV) without adjusting a reception field-of-view (Rx FoV) to monitor certain unknown objects 110, such as tire debris, within an environment external to the vehicle 104.

The SDS 102 includes multiple sensor assemblies that each include one or more sensors 106 to monitor a 360-degree FoV around the vehicle 104 in the near-field and the far-field. The SDS 102 includes a top sensor assembly 112, two side sensor assemblies 114, two front sensor assemblies 116, and a rear sensor assembly 118, according to aspects of the disclosure. Each sensor assembly includes one or more sensors 106, such as a camera, a lidar sensor, and a radar sensor.

The top sensor assembly 112 is mounted to a roof of the vehicle 104 and includes multiple sensors 106, such as a lidar sensor and multiple cameras. The lidar sensor rotates about an axis to scan a 360-degree FoV about the vehicle 104. The side sensor assemblies 114 are mounted to a side of the vehicle 104, such as to a front fender as shown in FIG. 1, or within a side view mirror. Each side sensor assembly 114 includes multiple sensors 106, for example, a lidar sensor and a camera to monitor a FoV adjacent to the vehicle 104 in the near-field. The front sensor assemblies 116 are mounted to a front of the vehicle 104, for example, below the headlights. Each front sensor assembly 116 includes multiple sensors 106, such as a lidar sensor, a radar sensor, and a camera to monitor a FoV in front of the vehicle 104 in the far-field. The rear sensor assembly 118 is mounted to an upper rear portion of the vehicle 104, for example, adjacent to a Center High Mount Stop Lamp (CHMSL). The rear sensor assembly 118 includes multiple sensors 106, such as a camera and a lidar sensor for monitoring the FoV behind the vehicle 104.

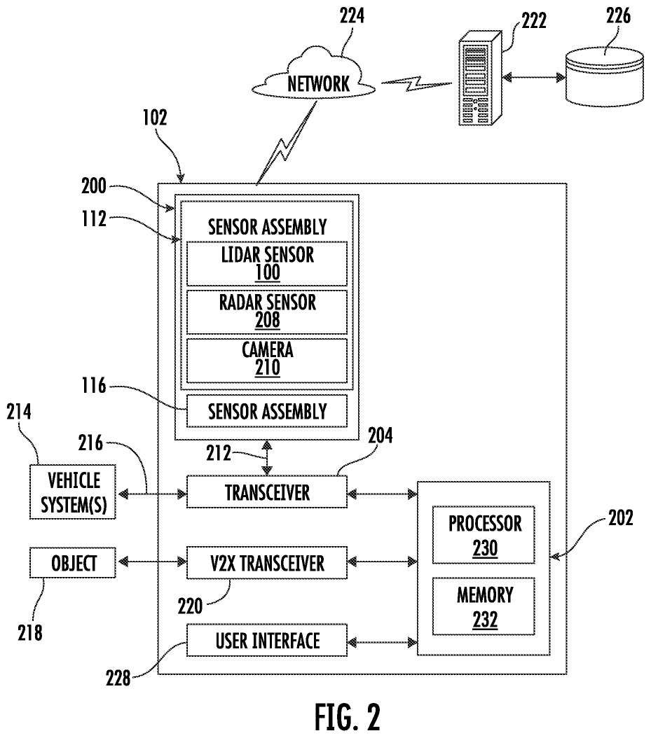

FIG. 2 illustrates communication between the SDS 102 and other systems and devices according to aspects of the disclosure. The SDS 102 includes a sensor system 200 and a controller 202. The controller 202 may communicate with other systems and devices directly, or through a transceiver 204.

The sensor system 200 includes the sensor assemblies, such as the top sensor assembly 112 and the front sensor assembly 116. The top sensor assembly 112 includes one or more sensors, such as the lidar sensor 100, a radar sensor 208, and a camera 210. The camera 210 may be a visible spectrum camera, an infrared camera, etc., according to aspects of the disclosure. The sensor system 200 may include additional sensors, such as a microphone, a sound navigation and ranging (SONAR) sensor, temperature sensors, position sensors (e.g., global positioning system (GPS), etc.), location sensors, fuel sensors, motion sensors (e.g., inertial measurement units (IMU), etc.), humidity sensors, occupancy sensors, or the like. The sensor system 200 provides sensor data 212 that is indicative of the external environment of the vehicle 104. The controller 202 analyzes the sensor data to identify and determine the location of external objects relative to the vehicle 104, such as the location of traffic lights, remote vehicles, pedestrians, etc.

The SDS 102 also communicates with one or more vehicle systems 214, such as an engine, a transmission, a navigation system, a brake system, etc. through the transceiver 204. The controller 202 may receive information from the vehicle systems 214 that is indicative of present operating conditions, e.g., vehicle speed, engine speed, turn signal status, brake position, vehicle position, steering angle, and ambient temperature. The controller 202 may also control one or more of the vehicle systems 214 based on the sensor data 212, for example, the controller 202 may control a braking system and a steering system to avoid an obstacle. The controller 202 may communicate directly with the vehicle systems 214 or communicate indirectly with the vehicle systems 214 over a vehicle communication bus, such as a CAN bus 216.

The SDS 102 may also communicate with external objects 218, e.g., remote vehicles and structures, to share the external environment information and/or to collect additional external environment information. The SDS 102 may include a vehicle-to-everything (V2X) transceiver 220 that is connected to the controller 202 for communicating with the objects 218. For example, the SDS 102 may use the V2X transceiver 220 for communicating directly with a remote vehicle vehicle-to-vehicle (V2V) communication, a structure (e.g., a sign, a building, or a traffic light) by vehicle-to-infrastructure (V21) communication, and a motorcycle by vehicle-to-motorcycle (V2M) communication.

The SDS 102 may communicate with a remote computing device 222 over a communications network 224 using one or more of the transceivers 204, 220, for example, to provide a message or visual that indicates the location of the objects 218 relative to the vehicle 104, based on the sensor data 212. The remote computing device 222 may include one or more servers to process one or more processes of the technology described herein. The remote computing device 222 may also communicate data with a database 226 over the network 224.

The SDS 102 includes a user interface 228 to provide information to a user of the vehicle 104. The controller 202 may control the user interface 228 to provide a message or visual that indicates the location of the objects 218 relative to the vehicle 104, based on the sensor data 212.

Although the controller 202 is described as a single controller, it may contain multiple controllers, or may be embodied as software code within one or more other controllers. The controller 202 includes a processing unit, or processor 230, that may include any number of microprocessors, ASICs, ICs, memory (e.g., FLASH, ROM, RAM, EPROM and/or EEPROM) and software code to co-act with one another to perform a series of operations. Such hardware and/or software may be grouped together in assemblies to perform certain functions. Any one or more of the controllers or devices described herein include computer executable instructions that may be compiled or interpreted from computer programs created using a variety of programming languages and/or technologies. The controller 202 also includes memory 232, or non-transitory computer-readable storage medium, that is capable of executing instructions of a software program. The memory 232 may be, but is not limited to, an electronic storage device, a magnetic storage device, an optical storage device, an electromagnetic storage device, a semi-conductor storage device, or any suitable combination thereof. In general, the processor 230 receives instructions, for example from the memory 232, a computer-readable medium, or the like, and executes the instructions. The controller 202, also includes predetermined data, or “look up tables” that is stored within memory, according to aspects of the disclosure.

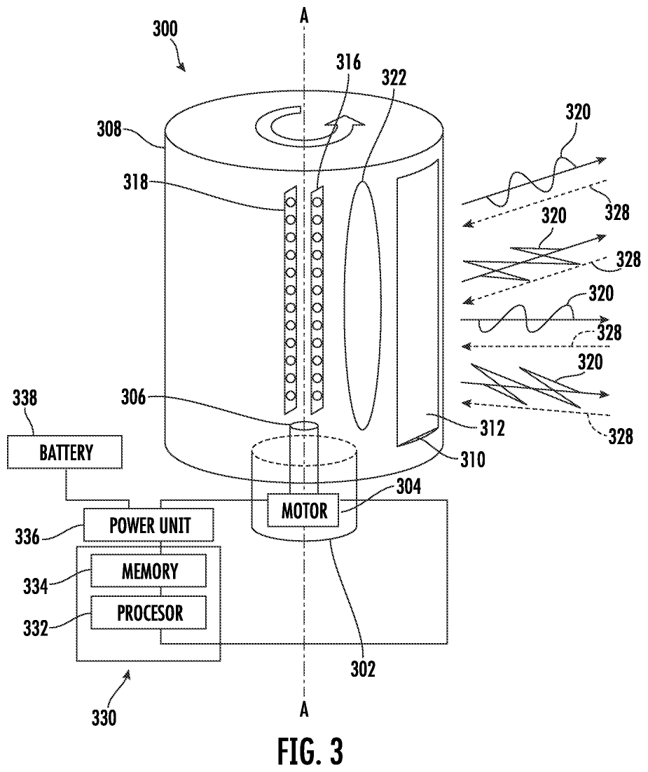

FIG. 3 illustrates an exemplary architecture of a lidar sensor 300, such as the lidar sensor 100 of the top sensor assembly 112, according to aspects of the disclosure. The lidar sensor 300 includes a base 302 that is mounted to the vehicle 104. The base 302 includes a motor 304 with a shaft 306 that extends along an axis A-A. The lidar sensor 300 also includes a housing 308 that is secured to the shaft 306 and mounted for rotation relative to the base 302 about Axis A-A. The housing 308 includes an opening 310, and a cover 312 that is secured within the opening 310. The cover 312 is formed of a material that is transparent to light, e.g., glass. Although a single cover 312 is shown in FIG. 3, the lidar sensor 300 may include multiple covers 312, or a cover 312 that spans the entire outer surface of the housing 308.

The lidar sensor 300 includes one or more emitters 316 for transmitting light pulses 320 through the cover 312 and away from the vehicle 104 to a Tx FoV (shown in FIG. 1). The light pulses 320 are incident on one or more objects within the Rx FoV, and reflect back toward the lidar sensor 300 as reflected light pulses 328. The lidar sensor 300 also includes one or more detectors 318 for receiving the reflected light pulses 328 that pass through the cover 312. The detectors 318 also receive light from external light sources, e.g., the sun. The lidar sensor 300 rotates about Axis A-A to scan the region within its FoV. The emitters 316 and the detectors 318 may be stationary, e.g., mounted to the base 302, or dynamic and mounted to the housing 308.

The emitters 316 may include laser emitter chips or other light emitting devices and may include any number of individual emitters (e.g., 8 emitters, 64 emitters, or 128 emitters). The emitters may arranged in a linear array, or laser bar, as illustrated in FIG. 3. The emitters 316 may transmit light pulses 320 of substantially the same intensity or of varying intensities, and in various waveforms, e.g., sinusoidal, square-wave, and sawtooth. The lidar sensor 300 may include one or more optical elements 322 to focus and direct light that is passed through the cover 312.

The detectors 318 may include a photodetector, or an array of photodetectors, that is positioned to receive the reflected light pulses 328. The detectors 318 may be arranged in a linear array, as illustrated in FIG. 3. According to aspects of the disclosure, the detectors 318 include a plurality of pixels, wherein each pixel includes a Geiger-mode avalanche photodiode, for detecting reflections of the light pulses during each of a plurality of detection frames. In other embodiments, the detectors 318 include passive imagers.

The lidar sensor 300 includes a controller 330 with a processor 332 and memory 334 to control various components, such as the motor 304, the emitters 316, and the detectors 318. The controller 330 also analyzes the data collected by the detectors 318, to measure characteristics of the light received, and generates information about the environment external to the vehicle 104. For example, the controller 330 may generate a three-dimensional point cloud based on the data collected by the detectors 318. The controller 330 may be integrated with another controller, such as the controller 202 of the SDS 102. The lidar sensor 300 also includes a power unit 336 that receives electrical power from a vehicle battery 338, and supplies the electrical power to the motor 304, the emitters 316, the detectors 318, and the controller 330.

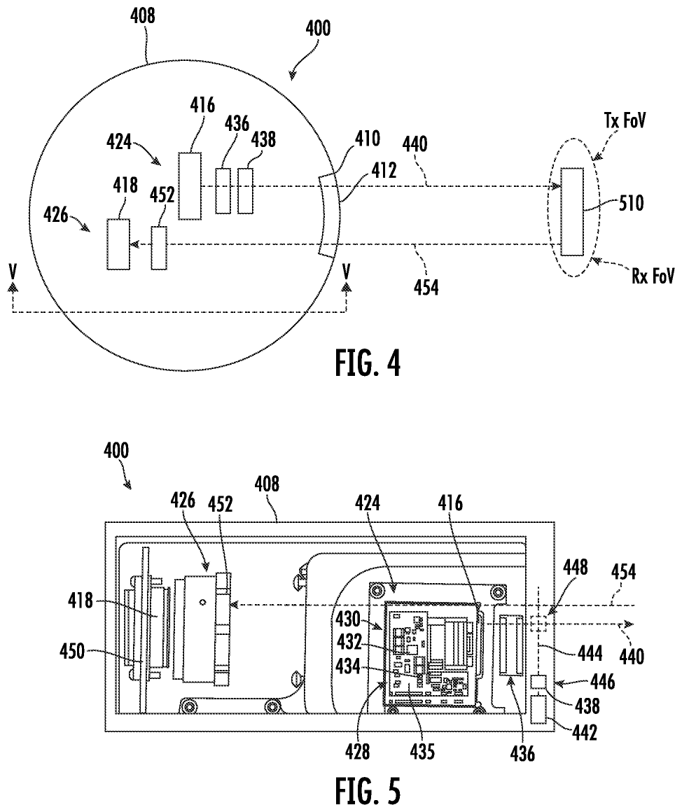

FIGS. 4 and 5 illustrate an exemplary lidar sensor 400. Like the lidar sensor 300 of FIG. 3, the lidar sensor 400 includes a housing 408 with an opening 410 and a cover 412 that is secured within the opening 410. The lidar sensor 400 includes one or more emitters 416 for transmitting light pulses through the cover 412 and one or more detectors 418 for receiving the reflected light pulses that pass through the cover 412. According to aspects of the disclosure, the emitters 416 and the detectors 418 are each arranged in a linear array. The lidar sensor 300 includes a transmitter assembly 424 that includes the emitters 416, and a receiver assembly 426 that includes the detectors 418.

The transmitter assembly 424 includes a circuit board assembly 428 for controlling the emitters 416. The circuit board assembly 428 includes a controller 430 with a processor 432 and memory 434 that are mounted to a circuit board 435.

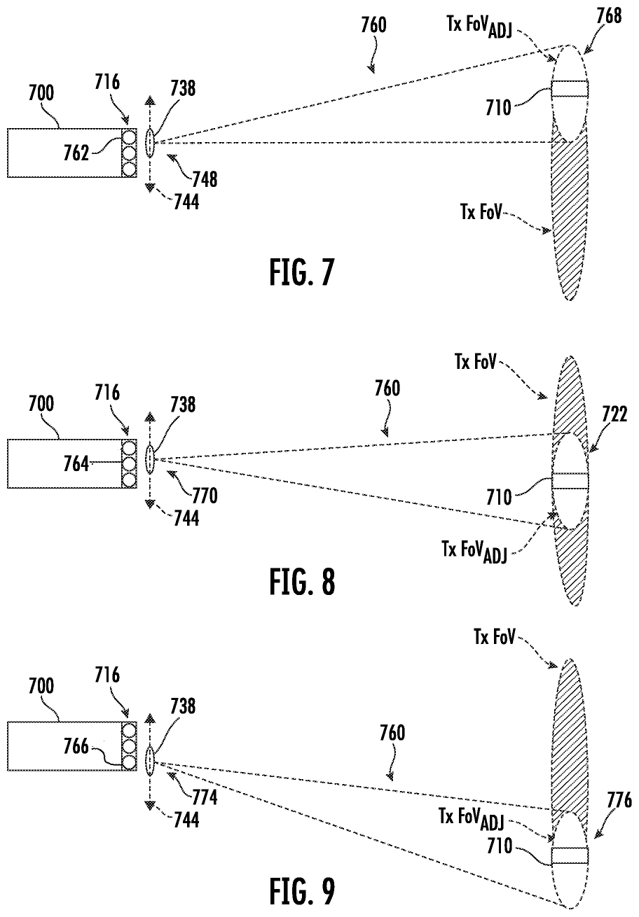

The transmitter assembly 424 also includes a plurality of optical elements including collimators 436 and a transmit optic 438. The collimators 436 focus and direct the light pulses from each emitter 416 along a transmission (Tx) axis 440 to collectively form a Tx beam, as shown in FIG. 7. The transmit optic 438 is arranged between the collimators 436 and the cover 412 to focus the Tx beam toward a smaller region of the Tx FoV. The transmit optic 438 may be a converging lens, such as a cylindrical lens, that focuses the light pulses onto a single axis. The transmitter assembly 424 also includes an actuator 442, such as a linear actuator, that is connected to the transmit optic 438 and controlled by the controller 430. The actuator 442 translates the transmit optic 438 along a transverse axis 444 that is arranged perpendicular to the Tx axis 440. The actuator 442 provides linear adjustment of the transmit optic 438 from a rest position 446, in which the transmit optic 438 does not intersect any of the Tx Axes, to a fully extended position 448 in which the transmit optic 438 intersects the Tx axis of the distal most emitter of the linear array of emitters 416. The actuator 442 may adjust the transmit optic 438 based on the rotational speed of the lidar sensor 400, according to aspects of the disclosure. For example, in one embodiment, the lidar sensor 400 rotates at 10 Hz, or 600 revolutions per minute (RPM), and the actuator 442 adjusts the transmit optic 438 from the rest position 446 to the distal position 448 in 100 milliseconds (ms). The actuator 442 may be a linear actuator, such as a voice coil. The stroke, or linear adjustment, of the actuator 442 is based on the length of the linear array of the emitters 416, according to aspects of the disclosure.

The receiver assembly 426 includes the detectors 418, which are mounted to a circuit board 450. The controller 430 is connected to the circuit board 450 to receive data from the detectors 418. The controller 430 analyzes the data collected by the detector 418 and generates information about the environment surrounding the lidar sensor 400. The receiver assembly 426 also includes one or more detector optics 452. The detector optics 452 may include a collimator to focus and direct the received light pulses to each detector 418 along a reception (Rx) axis 454.

Referring to FIG. 4, the transmitter assembly 424 is offset from the receiver assembly 426. As the transmit optic 438 is translated along the transverse axis 444, the transmit optic 438 intersects the Tx axis 440, but not the Rx axis 454. The Tx FoV and the Rx FoV overlap, as illustrated in FIG. 4. However, since the transmit optic 438 does not intersect the Rx axis 454, the lidar sensor 400 can adjust the Tx FoV to track an object 510 without adjusting the Rx FoV.

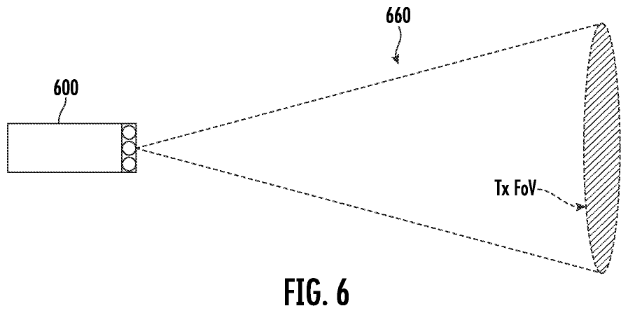

FIG. 6 illustrates an exemplary lidar sensor 600. Like the lidar sensor 400, the lidar sensor 600 emits light pulses that collectively form a Tx beam 660 within a Tx FoV. Unlike the lidar sensor 400, the lidar sensor 600 does not include a transmit optic 438 for adjusting the Tx FoV.

FIGS. 7-9 illustrate another exemplary lidar sensor 700. Like the lidar sensor 400, the lidar sensor 700 includes a series of emitters 716 that emit light pulses that collectively form a Tx beam 760 within a Tx FoV. Also, like the lidar sensor 400, the lidar sensor 700 includes a transmit optic 738 to form an adjusted Tx FoV (Tx FoV_{ADJ}) The lidar sensor 700 includes a series of emitters 716 that are arranged in a linear array, including a distal emitter 762, a central emitter 764, and a proximal emitter 766. FIGS. 7-9 illustrate a comparison between the Tx FoV and the Tx FoV_{ADJ} as the transmit optic 738 is translated along the transverse axis 744.

FIG. 7 illustrates the transmit optic 738 adjusted to a distal position 748 to intersect the Tx Axis of the distal emitter 762, and to generate a Tx FoV_{ADJ} at an upper region 768 of the overall, or not adjusted, Tx FoV. FIG. 8 illustrates the transmit optic 738 adjusted to an intermediate position 770 to intersect the Tx Axis of the central emitter 764, and to generate a Tx FoV_{ADJ} at a central region 772 of the overall Tx FoV. FIG. 9 illustrates the transmit optic 738 adjusted to a proximate position 774 to intersect the Tx Axis of the proximate emitter 766, and to generate a Tx FoV_{ADJ} at a lower region 776 of the overall Tx FoV. The controller 430 may adjust the position of the transmit optic 738 so that the adjusted Tx FoV tracks an object 710, such as a tire or tire debris.

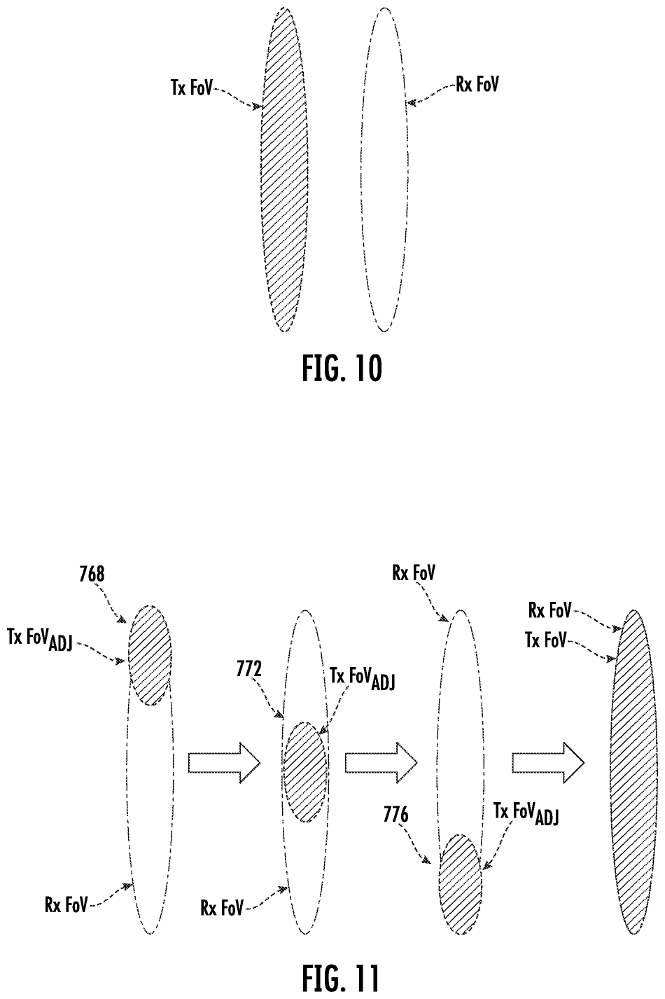

FIGS. 10-11 illustrate the Tx FoV in comparison to the Rx FoV. With reference to FIG. 10, the Tx FoV and the Rx FoV are oriented adjacent to one another to illustrate that both fields-of-view are the same size, but they overlap in the environment external to the vehicle 104, as shown in FIG. 11. FIG. 11 also illustrates an adjusted Tx FoV after it is adjusted by the transmit optic 438. As the transmit optic 438 is translated along the transverse axis 444, the adjusted Tx FoV shifts to overlap different regions of the Rx FoV. For example, and referring back to FIGS. 6-9, when the transmit optic 738 is located in the distal position 748 (FIG. 7), the lidar sensor 700 generates a Tx FoV_{ADJ} at the upper region 768 of the Rx FoV. Then when the transmit optic 738 is adjusted to the intermediate position 770 (FIG. 8), the lidar sensor 700 generates a Tx FoV_{ADJ} at the central region 772 of the Rx FoV. When the transmit optic 738 is adjusted to the proximate position 774 (FIG. 9), the lidar sensor 700 generates the Tx FoV_{ADJ} at the lower region 776 of the Rx FoV. Once the transmit optic 738 is adjusted to the rest position (shown in FIG. 4) in which it does not intersect any of the Tx Axes, the Tx FoV returns to its full range and overlaps the Rx FoV, as shown on the right side of FIG. 11.

As the adjusted Tx FoV is shifted between different regions, the Rx FoV remains unchanged. This allows for a longer range out of a wider FoV. Typically, the wider the FoV, the less ability the optics have to scan a small target region. In other words, a wider FoV means there is less light available to scan an object so in order to get a clear image, the width is reduced. However, by adjusting the Tx FoV, without adjusting the Rx FoV, more light can be focused on a small target region without minimizing the width of the FoV, to identify an unknown object 710, such as a tire or tire debris.

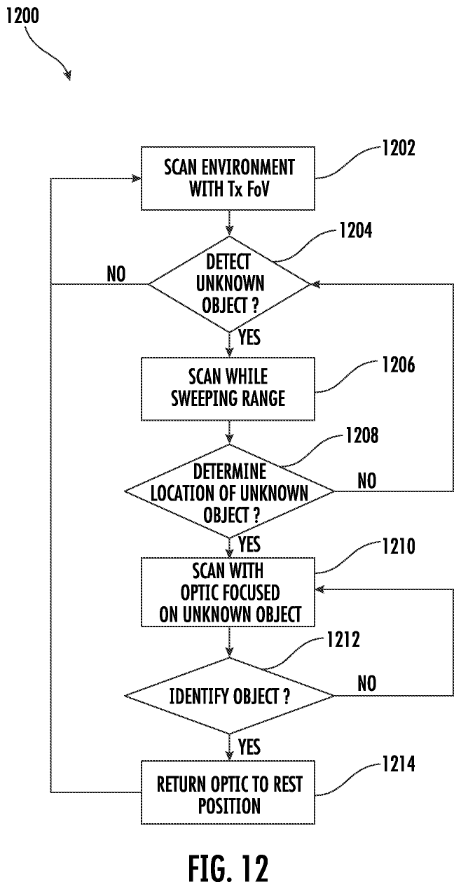

With reference to FIG. 12, a flow chart depicting a method for adjusting a Tx FoV is illustrated in accordance with one or more embodiments and is generally referenced by numeral 1200. The method 1200 is implemented using software code that is executed by the controller 430, according to one or more embodiments. While the flowchart is illustrated with a number of sequential steps, one or more steps may be omitted and/or executed in another manner without deviating from the scope and contemplation of the present disclosure.

At step 1202, the controller 430 controls the lidar sensor 400 to scan a 360-degree field-of-view about the vehicle 104 with a full Tx FoV. The transmit optic 438 is located at the rest position 446 (FIG. 4) and does not adjust the Tx FoV. The controller 430 analyzes the data from the emitters 416 to observe any environmental changes. At step 1204, the sensor 400 determines if an unknown object 710, such as a tire or tire debris, is detected outside the vehicle and within the Rx FoV. If no such object is detected, the controller 430 returns to step 1202. If the controller 430 detects an unknown object 710 at step 1204, it proceeds to step 1206.

At step 1206, the controller 430 controls the lidar sensor 400 to perform another scan, or series of scans, while sweeping the Tx FoV. During step 1206, the controller 430 sweeps the Tx FoV by controlling the actuator 442 to translate the transmit optic 438 through a predetermined range, for example between the proximate position 774 and the distal position 748 at a predetermined rate. In one embodiment, the controller 430 controls the transmit optic 438 to translate through its full range of 10 mm in 100 ms, or 0.1 m/s.

At step 1208, the controller 430 analyzes the sweep data to determine the location of the unknown object 710. If the controller 430 determines the location of the unknown object 710, it proceeds to step 1210. If the controller 430 does not determine the location of the unknown object 710, it returns to step 1204.

At step 1210, after determining the location of the unknown object 710, the controller 430 controls the lidar sensor 400 to track the unknown object 710 by performing another scan, or series of scans, with the transmit optic 438 focused on the unknown object 710. During this step, the transmit optic 438 is translated to a position that corresponds to a region within the FoV in which the unknown object 710 is located.

At step 1212, the controller 430 analyzes the focused scan data to identify the unknown object 710. If the controller 430 is not able to identify the unknown object 710, it returns to step 1210. Once the controller 430 identifies the unknown object 710, it proceeds to step 1214 and returns the transmit optic 438 to the rest position, and then returns to step 1202.

By focusing the Tx FoV on an unknown object 710, the lidar sensor 700 may identify an unknown object 710 quickly by projecting more light onto it, and thereby collecting more reflected light from a region of interest within the overall Tx FoV. Such an approach improves the responsiveness of the SDS 102 in identifying and responding to an unknown object 710, as compared to other lidar systems that do not adjust the Tx FoV, such as the lidar sensor 600 illustrated in FIG. 6.

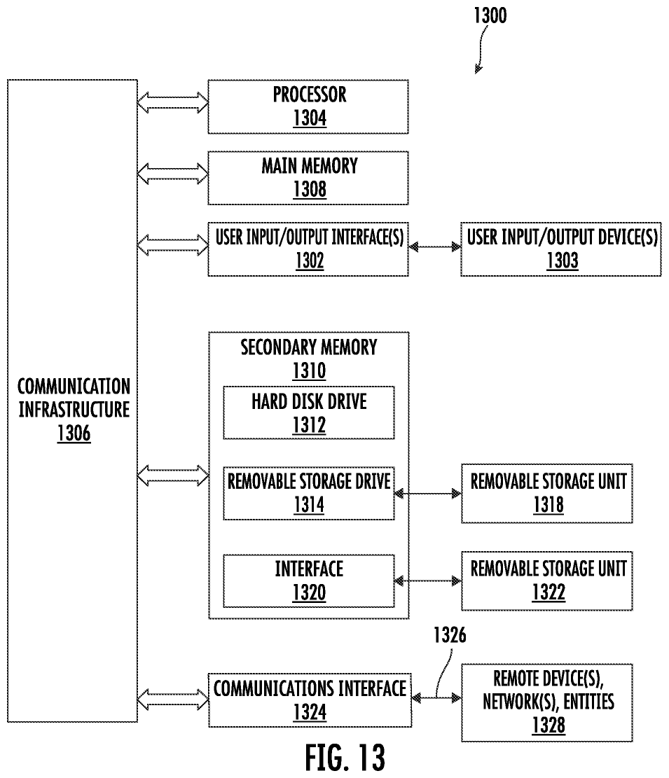

The method for adjusting the Tx FoV may be implemented using one or more controllers, such as the controller 430, or the computer system 1300 shown in FIG. 13. The computer system 1300 may be any computer capable of performing the functions described herein. The computer system 1300 also includes user input/output interface(s) 1302 and user input/output device(s) 1303, such as buttons, monitors, keyboards, pointing devices, etc.

The computer system 1300 includes one or more processors (also called central processing units, or CPUs), such as a processor 1304. The processor 1304 is connected to a communication infrastructure or bus 1306. The processor 1304 may be a graphics processing unit (GPU), e.g., a specialized electronic circuit designed to process mathematically intensive applications, with a parallel structure for parallel processing large blocks of data, such as mathematically intensive data common to computer graphics applications, images, videos, etc.

The computer system 1300 also includes a main memory 1308, such as random-access memory (RAM), that includes one or more levels of cache and stored control logic (i.e., computer software) and/or data. The computer system 1300 may also include one or more secondary storage devices or secondary memory 1310, e.g., a hard disk drive 1312; and/or a removable storage device 1314 that may interact with a removable storage unit 1318. The removable storage device 1314 and the removable storage unit 1318 may be a floppy disk drive, a magnetic tape drive, a compact disk drive, an optical storage device, tape backup device, and/or any other storage device/drive.

The secondary memory 1310 may include other means, instrumentalities or other approaches for allowing computer programs and/or other instructions and/or data to be accessed by computer system 1300, e.g., an interface 1320 and a removable storage unit 1322, e.g., a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

The computer system 1300 may further include a network or communication interface 1324 to communicate and interact with any combination of remote devices, remote networks, remote entities, etc. (individually and collectively referenced by reference number 1328). For example, the communication interface 1324 may allow the computer system 1300 to communicate with remote devices 1328 over a communication path 1326, which may be wired and/or wireless, and which may include any combination of LANs, WANs, the Internet, etc. The control logic and/or data may be transmitted to and from computer system 1300 via communication path 1326.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, the computer system 1300, the main memory 1308, the secondary memory 1310, and the removable storage units 1318 and 1322, as well as tangible articles of manufacture embodying any combination of the foregoing. Such control logic, when executed by one or more data processing devices (such as the computer system 1300), causes such data processing devices to operate as described herein.

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones and the like. An “autonomous vehicle” (or “AV”) is a vehicle having a processor, programming instructions and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle. Notably, the present solution is being described herein in the context of an autonomous vehicle. However, the present solution is not limited to autonomous vehicle applications. The present solution may be used in other applications such as robotic applications, radar system applications, metric applications, and/or system performance applications.

Based on the teachings contained in this disclosure, it will be apparent to persons skilled in the relevant art(s) how to make and use embodiments of this disclosure using data processing devices, computer systems and/or computer architectures other than that shown in FIG. 13. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other. The breadth and scope of this disclosure should not be limited by any of the above-described exemplary embodiments, but should be defined only in accordance with the following claims and their equivalents.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments.

What is claimed is:

1. A lidar sensor comprising:
a series of emitters, each emitter being configured to transmit light pulses away from a vehicle along a transmission axis to form a transmission field-of-view (Tx FoV);
at least one detector configured to receive at least a portion of the light pulses that reflect off of an object within a reception field-of-view (Rx FoV) along a reception axis; and
a transmit optic mounted for translation along a transverse axis and configured to intersect each transmission axis without intersecting the reception axis to adjust the Tx FoV without adjusting the Rx FoV.

2. The lidar sensor of claim 1, wherein the Tx FoV and the Rx FoV overlap, and wherein the adjusted Tx FoV is located within a region of the Tx FoV.

3. The lidar sensor of claim 1, further comprising a collimator mounted adjacent to the series of emitters and configured to focus and direct the light pulses along each transmission axis to collectively form a transmission beam.

4. The lidar sensor of claim 3, wherein the transmit optic is arranged adjacent to the collimator and configured to focus the transmission beam onto a region of the Tx FoV to form the adjusted Tx FoV.

5. The lidar sensor of claim 4, wherein the transmit optic comprises a cylindrical lens.

6. The lidar sensor of claim 1, wherein the series of emitters comprise a linear array of emitters arranged in parallel with the transverse axis, the linear array of emitters comprising a proximal emitter, and a distal emitter arranged opposite the proximal emitter.

7. The lidar sensor of claim 6, further comprising:
an actuator connected to the transmit optic and configured to translate the transmit optic through a range between a rest position, in which the transmit optic does not intersect any transmission axis of the linear array of emitters, and a distal position to intersect the transmission axis of the distal emitter.

8. The lidar sensor of claim 1, further comprising a controller configured to translate the transmit optic along the transverse axis.

9. The lidar sensor of claim 8, wherein the controller is further configured to:
determine, from the received light pulses, that the object is an unknown object; and
translate the transmit optic along the transverse axis between a proximal position and a distal position while transmitting light pulses through the transmit optic.

10. The lidar sensor of claim 9, wherein the controller is further configured to:
receive sweep data indicative of the light pulses that reflect off of the unknown object while translating the transmit optic;
determine a location of the unknown object based on the sweep data; and
translate the transmit optic to a position along the transverse axis such that the adjusted Tx FoV aligns with the location of the unknown object.

11. A method for adjusting a transmission field-of-view comprising:
transmitting light pulses away from a vehicle along at least one transmission axis to form a transmission field-of-view (Tx FoV);
receiving at least a portion of the light pulses that reflect off of an object within a reception field-of-view (Rx FoV) along a reception axis; and
translating a transmit optic along a transverse axis to intersect each transmission axis without intersecting the reception axis to adjust the Tx FoV without adjusting the Rx FoV.

12. The method of claim 11, further comprising:
determining, from the received light pulses, that the object is an unknown object; and
translating the transmit optic along the transverse axis to intersect each transmission axis while transmitting light pulses through the transmit optic.

13. The method of claim 12, further comprising:
receiving sweep data indicative of the light pulses that reflect off of the unknown object while translating the transmit optic; and
determining a location of the unknown object based on the sweep data.

14. The method of claim 13, further comprising:
translating the transmit optic to a position along the transverse axis corresponding to a region of the Rx FoV based on the location of the unknown object.

15. The method of claim 14, further comprising:
receiving focused scan data indicative of the light pulses that reflect off of the unknown object while the transmit optic is located at the position corresponding to the location of the unknown object;
identifying the unknown object based on the focused scan data; and
translating the transmit optic to the rest position along the transverse axis in response to identifying the unknown object.

16. A non-transitory computer-readable medium having instructions stored thereon that, when executed by at least one computing device, cause the at least one computing device to perform operations comprising:
transmitting light pulses away from a vehicle to form a transmission field-of-view (Tx FoV);
receiving at least a portion of the light pulses that reflect off of an object within a reception field-of-view (Rx FoV); and
translating a transmit optic along a transverse axis to adjust the Tx FoV without adjusting the Rx FoV.

17. The non-transitory computer-readable medium of claim 16 having instructions stored thereon that, when executed by at least one computing device, cause the at least one computing device to perform operations comprising:
determining, from the received light pulses, that the object is an unknown object; and
translating the transmit optic along the transverse axis to adjust the Tx FoV while transmitting light pulses through the transmit optic.

18. The non-transitory computer-readable medium of claim 17 having instructions stored thereon that, when executed by at least one computing device, cause the at least one computing device to perform operations comprising:
receiving sweep data indicative of the light pulses that reflect off of the unknown object while translating the transmit optic; and
determining a location of the unknown object based on the sweep data.

19. The non-transitory computer-readable medium of claim 18 having instructions stored thereon that, when executed by at least one computing device, cause the at least one computing device to perform operations comprising:
translating the transmit optic to a position along the transverse axis corresponding to a region of the Rx FoV based on the location of the unknown object.

20. The non-transitory computer-readable medium of claim 19 having instructions stored thereon that, when executed by at least one computing device, cause the at least one computing device to perform operations comprising:
receiving focused scan data indicative of the light pulses that reflect off of the unknown object while the transmit optic is located at the position corresponding to the location of the unknown object;
identifying the unknown object based on the focused scan data; and
translating the transmit optic to the rest position along the transverse axis in response to identifying the unknown object.
